(19) United States
(12) Patent Application Publication
(10) Pub. No.: US 2008/0273934 A1
(43) Pub. Date: Nov. 6, 2008

(54) Circular Cutter Having Improved Centering Characteristics

(75) Inventor: Mark A. Morgan, Tulsa, OK (US)

Correspondence Address: GABLE & GOTWALS, 100 WEST FIFTH STREET, 10TH FLOOR, TULSA, OK, 74103, US

(73) Assignee: TDW Delaware, Inc.

(21) Appl. No.: 11/743,455

(22) Filed: May 2, 2007

(51) Int. Cl. B23B 41/00

(52) U.S. Cl. 408/206

(57) ABSTRACT

A circular cutter is provided for use in cutting a hole through a main pipe wall from within a branch pipe, the circular cutter including a shaft rotated about a rotational axis, a circular cutter having at an outer end cutting teeth and an inner end secured to the shaft, and at least one centering ring secured to the circular cutter external cylindrical surface and of external diameter greater than the circular cutter external cylindrical surface and less than the internal diameter of the branch pipe, the centering ring serving to centrally position the circular cutter as it is rotated within the branch pipe and also serving to provide a positive stop to axial advancement of the circular cutter after it has cut through the main pipe wall.

### REFERENCE TO PENDING APPLICATIONS

This application is not based upon any pending domestic or international patent applications.

### FIELD OF THE INVENTION

This invention relates to a cylindrical cutter head for cutting a hole in a metal or plastic object, such as in the wall of a pipe, and wherein the hole has improved cylindricality.

### BACKGROUND OF THE INVENTION

This invention herein is an improved cylindrical hole cutter, referred to herein as a “circular cutter”. An example of the application of the circular cutter of this invention is for cutting a more accurately round hole in a pipe wall. When cutting a relatively large diameter hole in the wall of a relatively large diameter pipe the circular cutter undergoes substantial stress since when cutting initially starts the circular cutter engages the pipe only on portions that are 180° apart. As the cutting depth increases the amount of contact of the circular cutter with the pipe wall increases but usually the full 360° of the circular cutter does not contact the pipe at the same time. The forces encountered during cutting operations can cause a circular cutter to deflect, thus, forming an irregular shaped hole.

The tubular sidewall of a circular cutter is preferably relatively thin since the tubular sidewall must be no greater in thickness than the width of the cutting teeth. Obviously, if cutting teeth are wider more material is removed to cut a hole and more force is required to form a hole in a pipe or other object. The circular cutter must follow the teeth through the hole as it is cut. This means that a circular cutter tubular sidewall needs to be relatively thin but, at the same time, it must have sufficient rigidity to withstand the forces that are encountered in cutting through an irregular object while preserving concentricity about a rotational axis.

Others have provided cutting heads for cutting large diameter holes in metal objects such as illustrated in U.S. Pat. No. 1,441,994 issued to Mueller entitled “Shell Cutter And Drill For Drilling Machines”; U.S. Pat. No. 1,855,873 issued to Shortell entitled “Cutting Tool”; U.S. Pat. No. 4,422,812 issued to Linville entitled “Rotatable Shell Cutter”; U.S. Pat. No. 4,616,965 issued to Anderson et al entitled “Indexable Shell Cutter” and U.S. Pat. No. 4,968,192 issued to Hamilton entitled “Trepanning Tool”.

For background information relating to circular cutters particularly useful for cutting a hole in a sidewall of a pipe reference can also be had to U.S. Pat. No. 5,360,300, issued on Nov. 1, 1994, entitled “Cutter Shell”. This patent teaches a type of cutter shell in which the present invention pertains.

U.S. Pat. No. 5,451,128, issued on Sep. 19, 1995, and entitled “Cutter Tool Having Removable Teeth” describes a cutter shell and teaches improvements in replaceable teeth show how the teeth employed in a cutter shell can vary.

A most relevant prior art reference pertaining to the present invention is U.S. Pat. No. 5,466,099, dated Nov. 14, 1995, and entitled “Cutter Shell For Forming Holes of Improved Cylindricality”. This patent discloses a cutter having an abrasive band on the exterior tubular sidewall of the cutter that, on first impression, is similar to centering bands employed in Applicant's invention. However on full examination the present invention employs bands for completely different purposes and achieves results not contemplated by U.S. Pat. No. 5,466,099.

### BRIEF SUMMARY OF THE INVENTION

The invention herein is an improved circular cutter for use in cutting a circular hole through a main pipe wall to provide communication between the interior of the main pipe and a branch pipe. The improved circular cutter includes a pilot drill adapted to be rotated about a rotational axis. The circular cutter has, at its outer end, cutting teeth and includes a pilot drill supported in coaxial rotational alignment.

Affixed to the external cylindrical surface of the circular cutter is at least one, and preferably two, centering rings. The centering rings are spaced from the circular cutter outer end and are of external diameter slightly less than the internal diameter of the branch pipe.

The centering ring or rings serve to centrally position the circular cutter as it is rotated within the branch pipe.

Further, the centering rings serve to limit the axial advancement of the circular cutter to thereby provide a positive indication that it has extended through the wall of the main pipe and that the cutting operation has been completed.

A better understanding of the invention will be obtained from the following detailed description of the preferred embodiments taken in conjunction with the drawings and the attached claims.

### BRIEF DESCRIPTION OF THE DRAWINGS

Preferred embodiments of the invention will now be described in further detail. Other features, aspects, and advantages of the present invention will become better understood with regard to the following detailed description, appended claims, and accompanying drawings (which are not to scale) where:

FIG. 1 is an external elevational view of an embodiment of the circular cutter having improved centering characteristics of this invention.

FIG. 2 is an elevational cross-sectional view of a branch fitting secured to the upper half of the exterior of a main metallic pipe. A circular cutter having improved centering characteristics as revealed in this disclosure is positioned within the branch pipe for cutting a hole in the main pipe.

FIG. 3 is an fragmentary cross-sectional view showing a portion of the wall of a circular cutter having, in cross-section, a centering ring affixed to it.

FIG. 4 shows in elevational cross-section the entire circumference of a plastic main pipe and shows a plastic branch fitting that has been mechanically attached to the main pipe. Further, FIG. 4 shows a circular cutter positioned within the branch pipe and in position where it is ready to be employed to cut a hole through a circumferential portion of the branch fitting and then through the wall of the main pipe to provide communication between the interior of the main pipe and the branch fitting.

FIG. 5 is an end view of the circular cutter as taken along the line 5-5 of FIG. 1. FIG. 5 shows teeth of the type typically used for cutting through a metal pipe in which the teeth are of extremely hard material, like carbide steel. The type of teeth employed when the circular cutter of this invention is used to cut plastic pipe is entirely different however the principals of the invention remain the same.

FIG. 6 is an elevational isometric external view of a branch fitting mechanically secured to the exterior of a main pipe with the branch fitting including a coupling by which a branch pipe extends from the branch fitting. The coupling illustrated may be of the electrofusion-type but in which case the electrical contacts required for fusion are not shown. The coupling may also be a metal threaded coupling.

FIG. 7 is an isometric view of a circular cutter of this invention showing the typical teeth configuration and pilot drill configuration when the circular cutter is specifically designed to cut a hole in a plastic pipe. Whether the circular cutter of this disclosure is used for cutting through a metal pipe, typically a steel pipe, or through a plastic pipe, the principals of the invention are the same.

### DETAILED DESCRIPTION OF THE PREFERRED EMBODIMENTS

It is to be understood that the invention that is now to be described is not limited in its application to the details of the construction and arrangement of the parts illustrated in the accompanying drawings. The invention is capable of other embodiments and of being practiced or carried out in a variety of ways. The phraseology and terminology employed herein are for purposes of description and not limitation.

Elements shown by the drawings are identified by the following numbers:
10 Main pipe 46 Shaft
12 Branch pipe 50 First centering ring
14 Upper saddle portion 52 Second centering ring
16 Lower saddle portion 56 Bolts
18 Bolts 58 Threaded opening
20 Nuts 60 Opening
22 Branch pipe extension 62 Chamfered area
24 Coupling 64 Circumferential surface of 50
26 Circular cutter 65 Branch pipe interior surface
32 Outer end 66 Circular opening
34 Metal cutting teeth 68 Shoulder
36 Plastic cutting teeth 70 Passageway
38 Inner end 72 Closed area
40 Threaded bolt holes 74 Pilot drill for steel
42 Cutter holder 76 Pilot drill for plastic
44 Bottom end 78 Beveled ends

Referring to the drawings and first to FIG. 6, the environment in which the invention of this disclosure is used is illustrated. FIG. 6 shows an elongated main pipe 10. Main pipe 10 may be metal or non-metal. A metal pipe typically is made of steel that is commonly used to carry liquids or gases and may be positioned on or buried beneath the earth's surface. Main pipe 10 may also be of non-metallic material, such as, most commonly, of plastic. Main pipe 10 may be of other material besides metal and plastic but these two general categories encompass the vast majority of pipes utilized in the world today for moving liquids and gases.

FIG. 6 shows a branch pipe 12 extending at an angle from main pipe 10. Usually when a branch pipe is affixed to a main pipe it is affixed to extend radially of the main pipe, as illustrated in FIG. 6, but the angle can be other than radial. In FIG. 6 the branch pipe 12 is apart of a fitting including an upper saddle portion 14 and a lower saddle portion 16. The saddle portions 14 and 16 are held to each other and clamped around the exterior of main pipe 10 by four bolts 18 retained by nuts 20.

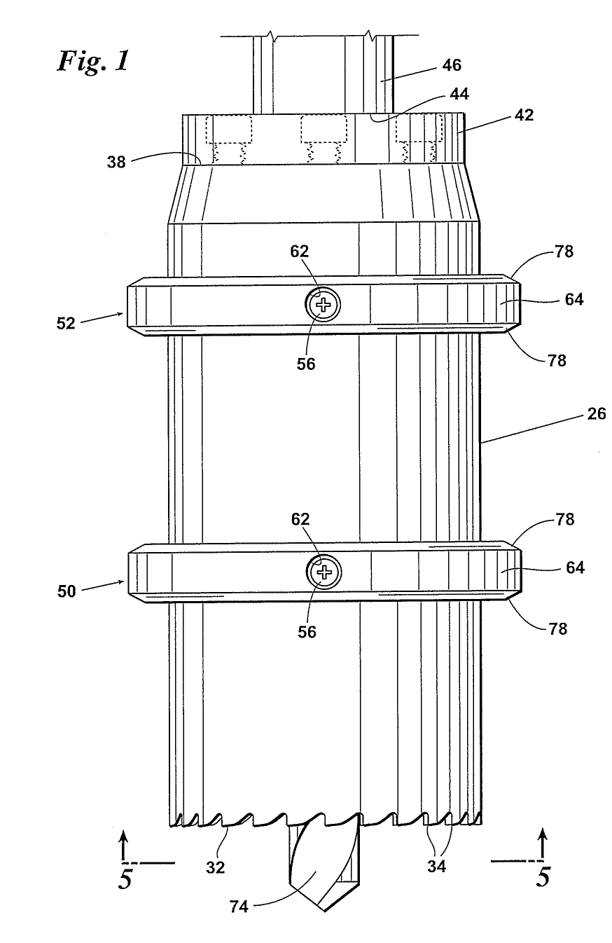

A branch pipe extension 22 is secured to branch pipe 12 by a coupling 24. If main pipe 10 and branch pipe 12 are of metal, then coupling 24 may be internally threaded and received on pipes that are threaded. When main pipe 10 and branch pipe 12 are plastic, then the coupling 24 will typically be of plastic and in which case the coupling 24 may be thermally fused in place. In any event and irrespective of whether attaching to a main pipe 10 that is plastic or metal the invention herein is not concerned with the branch fitting such as includes saddle portions 14 or the main pipe 10 or coupling 24 but the invention is an improved circular cutter for cutting a hole in main pipe 10 to provide communication between the interior of main pipe 10 and branch pipe 12. The improved circular cutter is illustrated in FIGS. 1-5 and 7 and will now be described.

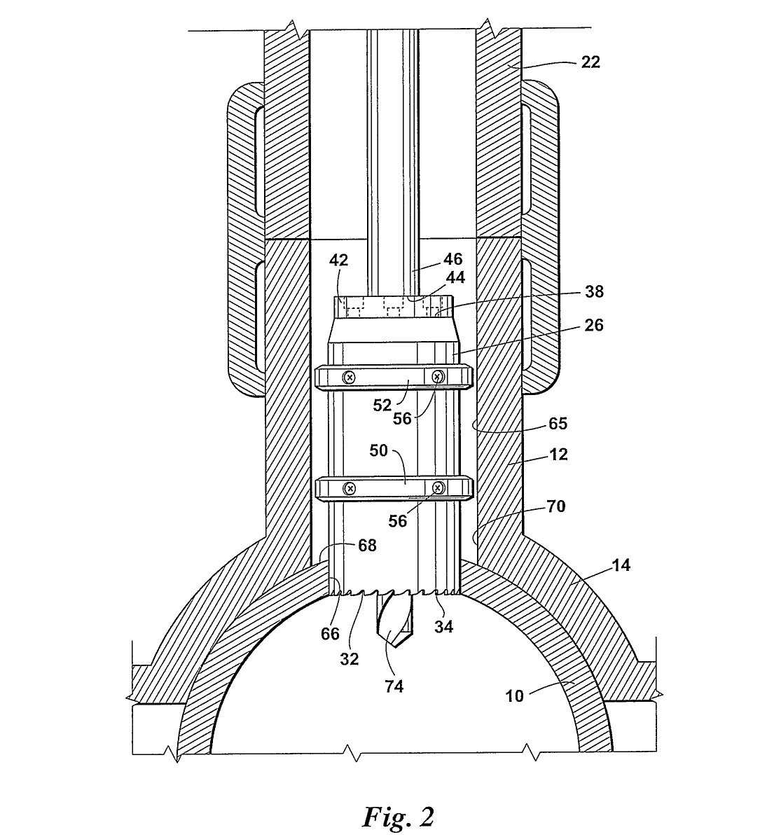

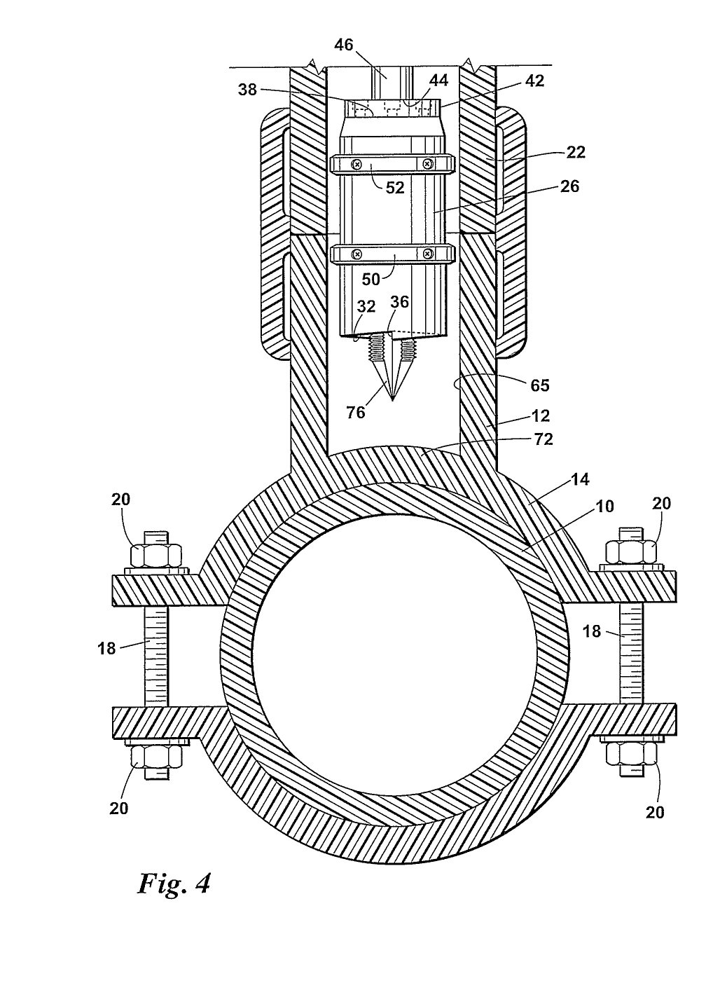

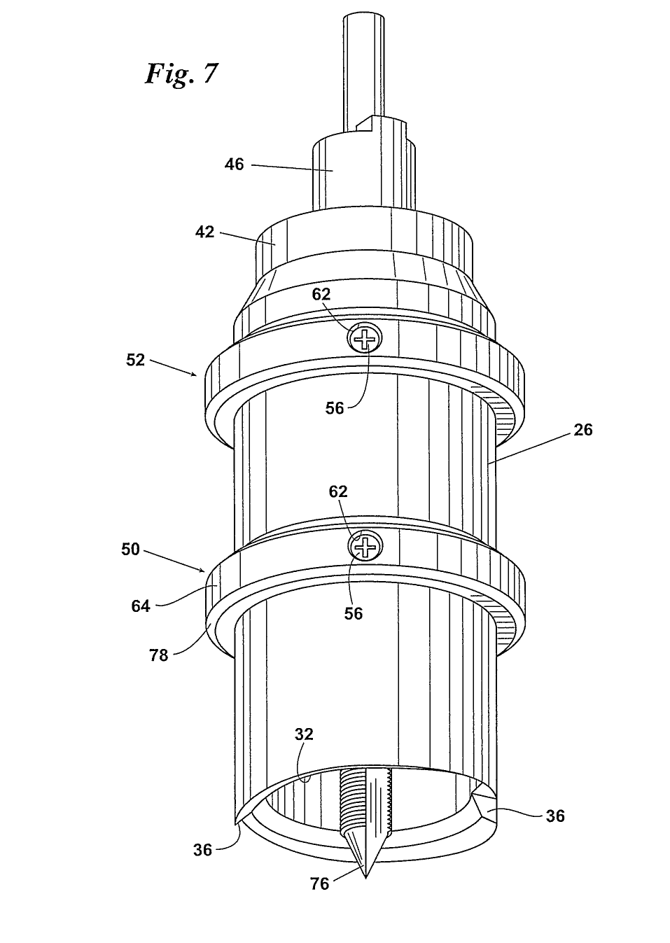

Referring now to FIGS. 2 and 4, improved circular cutters are illustrated in environments in which they are used. In both of FIGS. 2 and 4, main pipe 10, upper saddle portion 14, and branch pipe 12 are all shown in cross-section. The invention herein relates to an improved circular cutter generally indicated by the numeral 26. The circular cutter 26 has an outer end 32. The outer end 32 of circular cutter 26 of FIG. 2 has metal cutting teeth 34 thereon, while the outer end 32 of the plastic circular cutter of FIG. 4 has plastic cutting teeth 36. In FIG. 5, metal cutting teeth 34 are illustrated as being separate elements welded to the outer end 32 of the circular cutter 26 and this is by way of example only. It is not material to the invention herein whether the metal cutting teeth 34 of FIG. 5 are integrally formed with the circular cutter outer end 32 or are attached as separate elements. The particular configuration of the cutting teeth is not relevant to the invention. The cutting teeth shown in FIGS. 1, 2 and 5 are employed for cutting through a metal main pipe while FIGS. 4 and 7 illustrate teeth 36 particularly configured for cutting through plastic pipe.

The inner end 38 of circular cutter 26 is closed and typically is of thicker material than the sidewall. The closed inner end 38 provides a rigid base by which the circular cutter 26 is supported and rotated. In the illustrated arrangement, inner end 38 has a plurality of threaded bolt holes 40 as seen in dotted outline in FIG. 5. A planar cutter holder 42 is coaxially affixed to the bottom end 44 of a shaft 46 which may be a tapping machine boring bar. A tapping machine is not illustrated herein as it is a commonly known expedient in the piping industry, examples of which are illustrated in: U.S. Pat. No. 3,614,252 entitled “Tapping Apparatus”, issued Oct. 19, 1971; U.S. Pat. No. 4,579,484 entitled “Underwater Tapping Machine, issued Apr. 1, 1986; U.S. Pat. No. 5,439,331 entitled “High Pressure Tapping Apparatus”, issued Aug. 8, 1995; U.S. Pat. No. 6,012,878 entitled “Pressure Balanced Subsea Tapping Machine”, issued Jan. 11, 2000; and U.S. Pat. No. 6,648,562 entitled “Apparatus For Tapping A Hole In A Pipe”, issued Nov. 18, 2003.

The specific means by which shaft 46 is removably attached to circular cutter 26 is not illustrated since such can be accomplished in a number of ways, none of which relate to the essence of the present invention. Suffice to say, in the practice of the invention herein a tapping machine apparatus is affixed to branch pipe 12 or its extension 22 and provides energy to rotate a shaft 46 which is attached in any usual way to the circular cutter 26. The tapping machine controllably axially advances rotating circular cutter 26 to cut through the sidewall of main pipe 10, whether the pipe is metal or plastic.

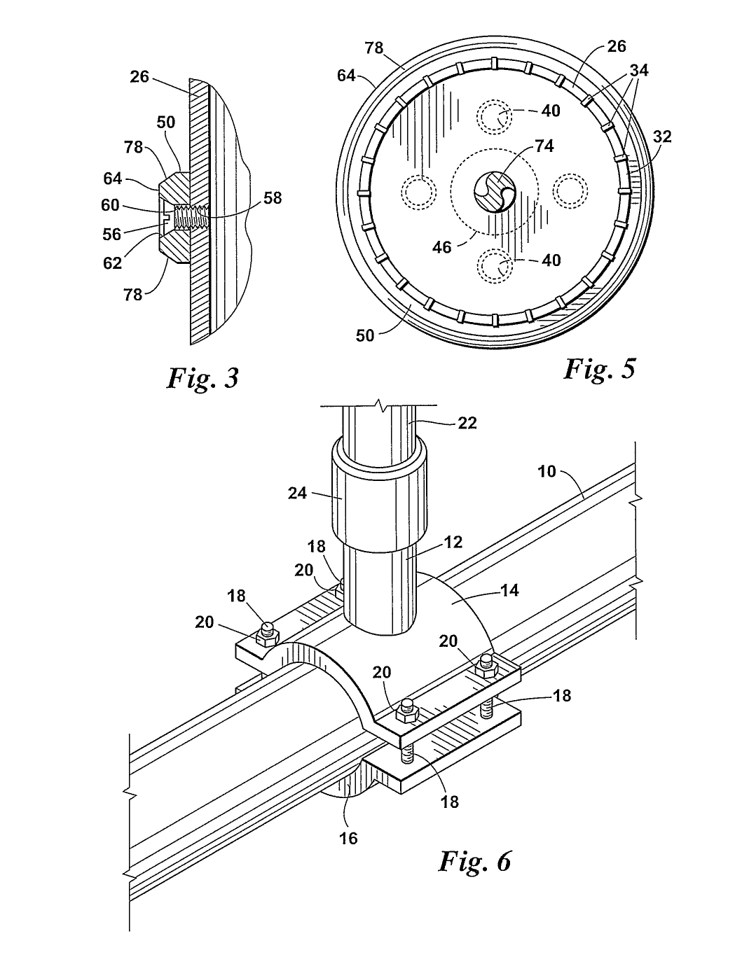

Since a tapping machine must be removably attached to the outer end of branch pipe 12, or its extension 22, the shaft 46 is traditionally of some significant length, that is, it cannot be extremely short as it extends from a rotating energy source to connect to circular cutter 26. This means that the tapping machine itself typically cannot rigidly support circular cutter 26 in a way to be certain that the circular cutter will always rotate precisely concentric to the rotational axis of shaft 46. To ensure more precise rotation of circular cutter 26 the invention herein provides a centering ring or centering rings positioned on the external cylindrical surface of the circular cutter. While a single centering ring 50 may in some applications be sufficient to provide support for the circular cutter, in the preferred arrangement and as are illustrated, two centering rings 50 and 52 are provided. Centering rings 50 and 52 can be unitary, that is, integral circumferential elements that slip in place onto the exterior surface of circular cutter 26 or each of the centering rings 50 and 52 can be segmented. As an example, each centering ring can be made up of two semi-circular segments or three or four segments can be employed. If a centering ring is made up of a plurality of segments, each segment preferably is retained by at least two bolts. As shown in FIG. 3, the segments are held in place by bolts 56 that thread into threading openings 58 in the circular cutter. Each bolt 56 extends through an opening 60 and the opening terminates in a chamfered area 62 adjacent the external circumferential surface 64 of each of the centering rings 50, 52. In this way the head of each bolt 56 is recessed below the centering ring external circumferential surface 64.

Centering rings 50, 52 serve two basic and very important functions. First, as the term “centering” suggests, each ring serves to stabilize and centralize the rotation of a circular cutter 26 within the interior surface 65 of branch pipe 12. By maintaining a consistent, fixed axis of rotation a circular opening 66, as seen in FIG. 2, is more precisely cut into main pipe 10. By maintaining a fixed axis of rotation of circular cutter 26 it not only cuts a more perfect circular opening in the main pipe but, in addition, the cutting action is more efficient and results in reduced material removal from the main pipe.

A second important function of centering rings 50, 52 is to provide a fixed limit on the axial advancement of a circular cutter 26. Referring to FIG. 2 it is apparent that the circular cutter 26 can be axially advanced to form circular open 66 in main pipe 10 but that the axial advancement will terminate when the first centering ring 50 encounters shoulder 68 formed in the interior of branch pipe 12. This reduces the unnecessary extension of the circular cutter into the interior of main pipe 10 after a hole has been cut in the wall of the main pipe and at the same time the certain stop of the axial advancement of the cutter serves assurance to the operator that a hole cut has been completed and therefore the drilling operation has not been terminated prematurely.

In FIG. 2 upper saddle portion 14 is provided with a passageway 70 that is of interior diameter greater than the diameter of the external surface of circular cutter 26. This is particularly important if the saddle portion 14 is made of metal. On the other hand, in FIG. 4 the upper saddle portion 14 having branch pipe 12 is closed by an integral circumferential portion 72. This arrangement would not be desirable if the branch pipe 14 is of metal since it would require the circular cutter 26 to first bore through the closed area 72 before boring through the wall of main pipe 10. However, when the branch pipe 14 is made of plastic or other non-metallic easily boreable material then the arrangement of FIG. 4 is acceptable since the circular cutter 26 can easily bore through the plastic of the upper saddle portion and then through the main pipe 10. In either situation the lowermost centering ring 50 serves to accurately guide the rotation of the circular cutter and also serves as a positive stop of the axial advancement of the circular cutter.

To aid in centering the rotation of circular cutter 26 it is provided with a pilot drill 74. When the circular cutter 26 is designed for cutting in a metal pipe, the pilot drill 74 is like a typical steel drill as seen in FIGS. 1, 2 and 5. However, when the circular cutter is configured for cutting through plastic, rather than metal, the pilot drill is differently constructed as identified by the numeral 76 in FIGS. 4 and 7.

Whether the centering drill is for steel or plastic the function is the same, that is, to guide the circular cutter through the main pipe. In the arrangement wherein the saddle is made of plastic and has a closed internal portion 72 as shown in FIG. 4, pilot drill 76 guides the circular cutter through the closed area 72 within upper saddle portion 14 and then through main pipe 10.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

What is claimed is:

1. For use in cutting a hole through a main pipe wall to provide communication between the interior of the main pipe and a branch pipe secured to and extending at an angle to the main pipe, an improved circular cutter comprising:
a shaft adapted to be rotated about a rotational axis and having an outer end;
a circular cutter having an external cylindrical surface, having at an outer end cutting teeth and an inner end secured to said shaft outer end, the circular cutter and said shaft being in coaxial rotational alignment; and
at least one centering ring secured to said circular cutter external cylindrical surface and spaced from said outer end, the centering ring being of external diameter greater than said cutter external cylindrical surface and less than the internal diameter of said branch pipe, the centering ring serving to centrally position said circular cutter as it is rotated within said branch pipe.

2. An improved circular cutter according to claim 1 including a spaced apart plurality of said centering rings.

3. An improved circular cutter according to claim 1 wherein said centering ring has an external surface defined by a central cylindrical portion and at each end a frusto-conical circumferential surface.

4. An improved circular cutter according to claim 1 wherein said centering ring has opposed beveled ends.

5. An improved circular cutter according to claim 1 wherein said centering ring is positioned on said circular cutter a selected distance from said cutting teeth to thereby limit the axial advancement of the circular cutter.

6. A circular cutter comprising:
a circular cutter having an external cylindrical surface, having at an outer end cutting teeth and having an inner end that can be secured for receiving rotational energy; and
at least one centering ring secured to said circular cutter external cylindrical surface and spaced from said cutter outer end and having an external cylindrical surface that is concentric with and of external diameter greater than said circular cutter external cylindrical surface.

7. A circular cutter according to claim 6 having a spaced apart plurality of said centering rings.

8. A circular cutter according to claim 6 wherein said centering ring has an external surface defined by a central cylindrical portion and at each end a frusto-conical circumferential surface.

9. A circular cutter according to claim 6 wherein said centering ring has opposed beveled ends.

10. A circular cutter according to claim 6 wherein said centering ring is positioned on said circular cutter at a selected distance from said cutting teeth to thereby limit the axial advancement of the circular cutter.
